(19) United States
(12) Patent Application Publication
(10) Pub. No.: US 2003/0012162 A1
(43) Pub. Date: Jan. 16, 2003

(54) Terminal agent representing wireless terminals in a voice over IP communication network

(76) Inventors: Subrata Mukherjee, Plano, TX (US); Kaushal Thakker, Irving, TX (US)

Correspondence Address: ERICSSON INC., 6300 LEGACY DRIVE, M/S EVW2-C-2, PLANO, TX, 75024, US

(21) Appl. No.: 09/821,479

(22) Filed: Jul. 16, 2001

(51) Int. Cl. H04Q 7/24

(52) U.S. Cl. 370/338; 370/349; 370/466

(57) ABSTRACT

A terminal agent (34) for interfacing a wireless terminal (26) with an IP network (12). The terminal agent (34) includes a Radio Base Station (40) for providing radio service to the wireless terminal (26) and a Radio Network Server (42) for control and signal processing. A Network Access Controller (44) provides for registration functions conversion of signals between wireless protocol and IP protocol for facilitating transmission of the signals in both the wireless and IP environments. In this way, the terminal agent (34) is able to provide service to the wireless terminal (26) as if it were a terminal of the IP network (12).

### TECHNICAL FIELD

This invention relates in general to interfacing Internet Protocol (IP) communication networks and wireless terminals and, in particular, to methods, systems and apparatus for providing wireless voice and data service in an IP communication network. More particularly, the invention relates to methods, systems and apparatus for allowing wireless terminal participation in an IP network as though the wireless terminal were an IP network terminal.

### BACKGROUND OF THE INVENTION

Increasingly, IP based networks are used for audio, video and data communications. Standards such as, for example, H.323 from the International Telecommunications Union (ITU) provide a framework for networks in current IP communication environments. Public Land Mobile Networks (PLMN) are also commonly employed to provide wireless voice and data communications to a plurality of subscribers through the use of wireless terminals. For example, Global Systems for Mobile communication (GSM) PLMNs have been introduced throughout the world.

Commonly, business enterprises are served by both IP network systems to carry data traffic and PLMN network systems as well as traditional Public Switched Telephone Network (PSTN) systems and possibly also private radio communication networks to carry voice traffic. A terminal from any one of these systems is able to provide services to a user only by interfacing with its own specialized protocol-based system components. This limitation creates duplication of effort, equipment, and expense.

Gateways of each system can provide a translation function between the system and other selected system types. For example, an IP network may have a PSTN gateway for interfacing with a PSTN. The use of gateways helps to connect the overlapping communication systems. Gateways are limited to performing system-to-system interface, however. Often, this results in the use of substantial resources from two or more complete networks in order to provide one terminal with requested services.

Accordingly, a need exists for systems, apparatus and methods for permitting mobile terminal participation in enterprise networks in general and IP networks in particular without using PLMN and PSTN infrastructure.

### SUMMARY OF THE INVENTION

The present invention discloses apparatus, systems, and methods for providing wireless voice and data services in an Internet Protocol (IP) network. The invention facilitates IP network detection of a wireless terminal request for service. A wireless interface is provided to the wireless terminal and an IP interface is provided to the IP network. The invention also converts between wireless protocol and IP protocol, permitting wireless terminal access to the IP network for services.

A communication system of the invention provides wireless terminal service in an IP network using a gatekeeper. The gatekeeper controls access by IP terminals to the IP network. The invention provides a terminal agent configured to facilitate IP network support of a wireless terminal not otherwise connected to the IP network. The terminal agent also interfaces with the gatekeeper as would an IP terminal of the IP network.

The invention also includes terminal agent apparatus for interfacing a wireless terminal with an IP network. The terminal agent includes a Radio Base Station (RBS) for providing radio service to a wireless terminal, and a Radio Network Server (RNS) for RBS control and signal processing. A Network Access Controller (NAC) coupled to the RNS provides for registration functions and conversion of signals between wireless protocol and IP protocol for facilitating the transmission of signals between the wireless terminal and IP network.

Particular technical advantages are achieved with the invention in permitting wireless terminal usage in an IP network. The invention permits expansion of an IP network to include wireless terminals, and also provides wireless terminals access to IP network resources without the use of PLMN infrastructure.

Other advantages are realized in that the invention is transparent with respect to wireless terminals and IP networks. That is, wireless terminals function as they would in their native PLMN, and the IP network treats the wireless terminals as IP terminals in the IP network.

According to one aspect, the invention may be practiced in an IP network using H.323 protocol wherein IP network resources have previously been inaccessible to wireless devices and vice versa, providing numerous advantages inherent in combining the capabilities of wireless terminals and IP network services.

Additional advantages of the invention inhere in the ability to provide services to wireless terminals without invoking PLMN infrastructure to support the wireless terminal.

### BRIEF DESCRIPTION OF THE DRAWINGS

The above advantages, as well as specific embodiments of the present invention, will be more clearly understood from consideration of the following descriptions in connection with accompanying drawings in which:

FIG. 1 is a block diagram illustrating an example of a prior art enterprise site supporting Internet Protocol (IP) in which the invention can be practiced;

FIG. 2 is a block diagram illustrating an example of the use of the invention with an incoming call from a PLMN terminal outside the terminal agent service area;

FIG. 3 is a block diagram illustrating the use of the invention with an incoming call from a PLMN terminal inside the terminal agent service area;

FIG. 4 is a block diagram illustrating an example of the use of the invention with an incoming call from a PSTN terminal;

FIG. 5 is a block diagram illustrating an example of the use of the invention with a call from an IP terminal to a mobile terminal in the service area of the invention;

FIG. 6 is a process flow diagram of the method of using the invention of FIGS. 2-5; and

FIG. 7 is a block diagram of the terminal agent of the invention.

Corresponding numerals and symbols in the various figures refer to corresponding parts unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. It should be understood that the invention may be practiced with IP networks and wireless terminals of various types. Some features of embodiments shown and discussed are simplified or exaggerated for illustrating the principles of the invention.

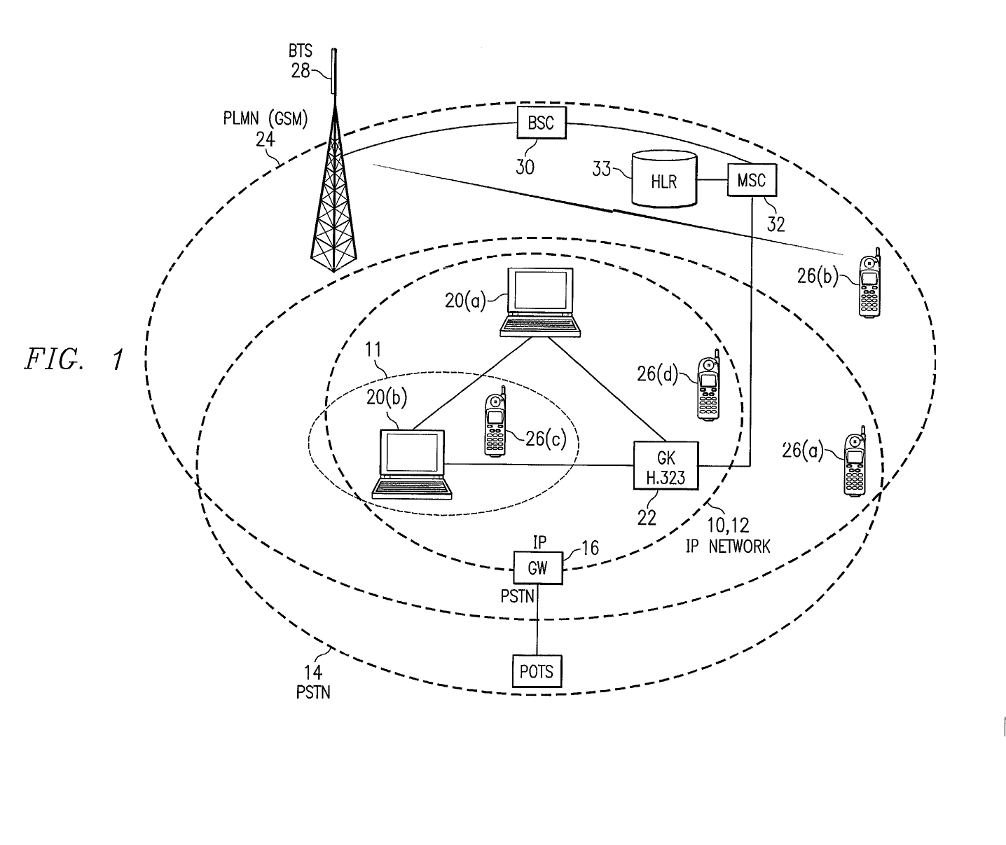

FIG. 1 is a block diagram showing an example of common communication networks in which the invention may be used. An enterprise site 10 is served by a corresponding Internet Protocol (IP) based network 12. For simplicity, the term “enterprise site” and “IP network” will be used interchangeably. The IP network 12 may be in the form of a Local Area Network (LAN), Virtual Local Network (VLAN), Wide Area Network (WAN) or other similar type of IP network. A telephone network 14 such as, for example a PSTN, also serves the enterprise site 10. In general, the IP network 12 has one or more gateways, such as a PSTN gateway 16, and a PLMN gateway 17 for interacting with the telephone network 14 and 24. The IP network 12 may, of course, have additional gateways for interfacing with other networks. The IP network 12 typically requires a separate gateway for interfacing between network protocols of each separate network with which interaction is desired. In the present example, the IP network 12 is furnished with IP terminals 20a:20b, and an H.323 gatekeeper 22 that provides address translation, access control, and bandwidth management for the IP network terminals 20a:20b. Commonly, the enterprise site 10 is concurrently served by one or more wireless Public Land Mobile Network (PLMN) 24 having wireless network terminals such as wireless terminals 26(a), 26(b), 26(c), and 26(d) (or 26a:26d).

It will be apparent to those skilled in the arts that many variations are possible from the enterprise site 10 shown in FIG. 1. For example, the enterprise site 10, may be located in one, two, or more geographical locations, themselves interacting with additional PLMNs and PSTNs. The simplified enterprise site 10 shown and described is presented for the sake of convenience in describing the features of the invention and not as a limitation. It should be assumed that an actual enterprise site in which the invention is practiced could have many additional terminals and would be more complex.

Those skilled in the arts will readily understand the common progression of a call from a terminal 26 of the wireless network 24 to a terminal 20 of the IP network 12. In general, a wireless network terminal, for example terminal 26(a), calling into the IP network 12 is first connected to the PLMN 24 through the various wireless network 24 components, such as a Base Transceiver Station (BTS) 28, Base Station Controller (BSC) 30, and Mobile Switching Center (MSC) 32. Finally, the wireless terminal 26(a) may communicate with a terminal of the IP network 12, for example a Voice Over IP (VoIP) terminal 20(a) using the route between the PLMN and IP networks 24, 12, that is: mobile terminal 26(a) to BTS 28; to BSC 30; to MSC 32; to GW 17; to gatekeeper 22; to IP terminal 20(b).

Of course, it will be understood that a call of this type requires at least the infrastructure of the PLMN 24 and the IP network 12. In general, a similar call scenario applies for wireless terminals located outside of the enterprise site 10, such as wireless terminal 26(b), and equally for wireless terminals which happen to be located within the enterprise site 10. Indeed, the same duplication of infrastructure typically would occur even for a wireless terminal located in same the office 11 as IP terminal 20(a), such as wireless terminal 26(c). That is, wireless terminal 26(c) of FIG. 1 would require the use of the PLMN 24 resources in order to contact IP terminal 20(a), even if the two terminals were in the same room. The present invention overcomes this limitation.

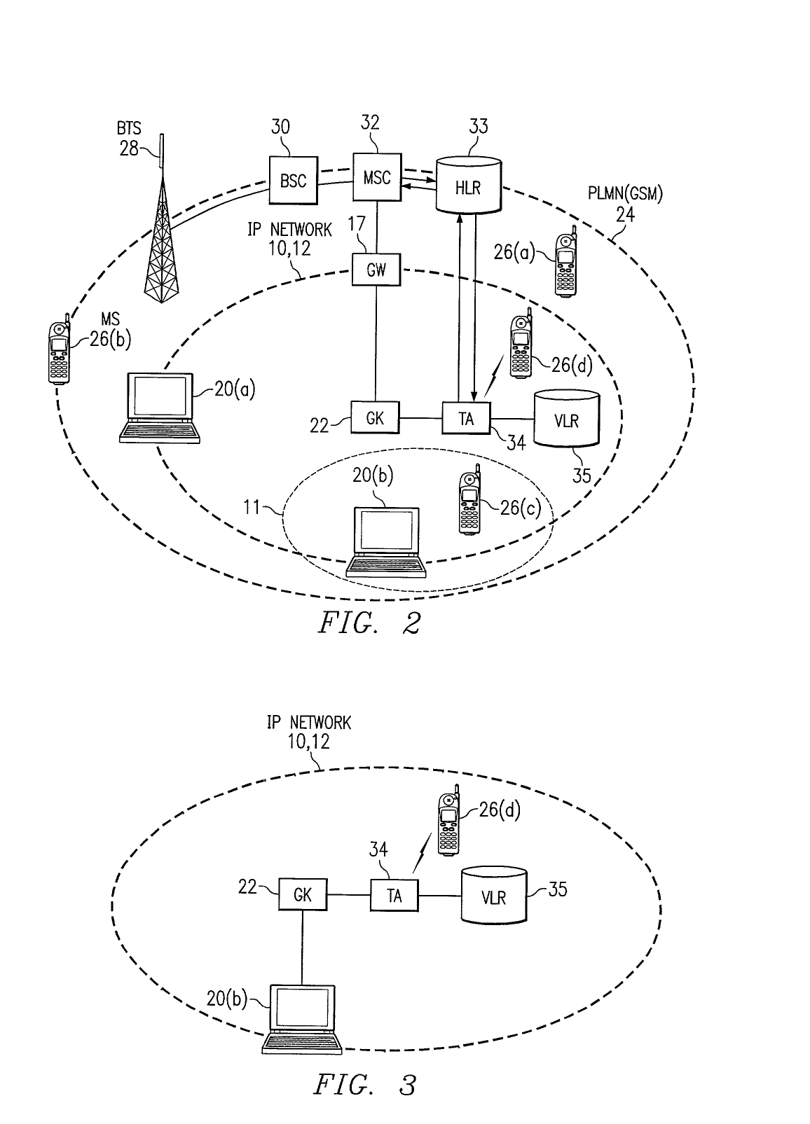

To better understand use of the invention, reference is made to FIGS. 2-4, which are diagrams illustrating examples of how the invention can be advantageously used in the enterprise site 10 of FIG. 1. Preferably, a GSM Terminal Agent (TA) 34 is shown in the IP network 12 communicably coupled to the gatekeeper 22. It should be understood that a non-GSM wireless terminal and TA could also be used. As such, a TA type for each mobile terminal type for which support is desired may be used. For example, a TA supporting Wideband Code Division Multiple Access (WCDMA) protocol may be used to interface with WCDMA compatible mobile terminals. TAs supporting other similar wireless protocols may also be employed.

Referring to FIG. 2, the progression of a call from PLMN mobile terminal 26(b) outside of the enterprise site 10 is shown and described. Mobile terminal 26(b) is located in PLMN network 24 and is outside of the enterprise site 10 and outside of the service area of the TA 34. Assuming that mobile terminal 26(b) places a call, using the appropriate Mobile Station Integrated Services Digital Network (MSISDN) number, to mobile terminal 26(d) located within the service area of TA 34 coinciding with the enterprise site 10, the following sequence occurs. Mobile terminal 26(b) is outside of the range of the terminal agent 34 of the enterprise site 10. Therefore, mobile terminal 26(b) is served by base station 28 of PLMN network 24 and the service request of mobile terminal 26(b) passes through the Base Transceiver Station (BTS) 28, Base Station Controller (BSC) 30 and Mobile Switching Center (MSC) 32 of the PLMN network 24. The MSC 32 seeks routing information from the HLR 33. The HLR 33, in turn, is provided a Mobile Station Roaming Number (MSRN) by the TA 34. The call may now be properly routed by the MSC 32.

Next, the call is transmitted through the IP network PLMN gateway 17 to the gatekeeper 22 of the IP network 12. Gatekeeper 22 then sets up the call towards GSM terminal agent 34. Terminal agent 34 performs a conversion to the appropriate mobile terminal protocol, and sends the call set up to its destination at mobile terminal 26(d). It should thus be apparent to one skilled in the arts that mobile terminal 26(d) is able to participate in the IP network 12 of the enterprise site 10 without invoking the resources of the PLMN network to which terminal 26(d) otherwise belongs.

Several advantages are illustrated by the preceding example of the use of the invention. Those skilled in the art will appreciate that although the originating mobile terminal 26(b) portion of the call was handled by the PLMN network 24 in a manner known in the art, the enterprise site mobile terminal 26(d) role in the call did not invoke any PLMN network resources on behalf of mobile terminal 26(d). Instead, the GSM terminal agent 34, compatible with the GSM mobile terminal 26(d) associated with the enterprise site 10 was able to emulate the wireless infrastructure required by mobile terminal 26(d). Additionally, terminal agent 34 provided the IP network 12 with a terminal end point compatible with the (H.323) IP network 12 capabilities. Furthermore, since TA 34 can be made to support other wireless protocols, such as CDMA, WCDMA, EDGE, or GPRS, for example, the invention provides a system for permitting participation in an IP-based infrastructure by a wide array of mobile terminal types.

Other advantages of the invention will suggest themselves to those skilled in the arts such as, for example, the possibility of two mobile terminals belonging to an enterprise site having the capability, through the use of one or more appropriate terminal agents, to communicate with one another without invoking their respective PLMN systems. This can occur even in situations where each mobile terminal is located at geographically separated portions of a single enterprise site, such as for example, Richardson, Tex. and Stockholm, Sweden.

Referring now to FIG. 3, and assuming for the sake of example that it is desired to connect terminal 20(b) to a mobile terminal, such as, for example, mobile terminal 26(b) inside the service area of the TA 34. The mobile terminal 26(d) may request access to the IP network 12 utilizing its standard wireless protocol. Note that for the purposes of this example, the enterprise site 10 coincides with the service area of the TA 34. Of course, this need not be the case. The TA 34 could have a service area larger or smaller than the enterprise site, and the enterprise site could, of course, be served by multiple TAs. Upon detecting the request for service from mobile terminal 26(d), the TA 34 makes a determination of whether mobile terminal 26(d) is eligible to participate in the IP network 12. It should be understood that the TA 34 may be configured to accept service requests from all compatible mobile terminals, in this case GSM mobiles, within the service area 10. Alternatively, the TA 34 may be preprogrammed to accept service requests from only particular GSM terminals based on individual International Mobile Subscriber Identities (IMSIs) on MSISDNs.

When the TA 34 receives a request for service from the wireless terminal 26(d), it examines an internal registration database to determine whether the wireless terminal 26(d) is already registered in its service area, in this example, within the service area of the TA 34. If the wireless terminal 26(d) is not previously registered, the TA 34 sends a registration message to the Home Location Register (HLR) 33 of the PLMN 24 of the wireless terminal 26(d) as well as to GK 22 serving the TA 34. It should be clear to those skilled in the arts that the registration functions of the TA 34 may be varied, according to the wireless terminal type being served in order to conform with the standard mobility management procedures of a particular PLMN. It should be understood that registration procedures known in the arts are used for mobility management according to the procedures of the particular type of PLMN or PLMNs with which the invention is used.

Referring to FIG. 2A, registration, e.g. location update procedure, is shown. A mobile terminal 26(n) contacts the TA 34. The TA 34, in turn, accesses the appropriate PLMN HLR 33 using the gatekeeper 22 and gateway 16. Registration of the mobile terminal 26(n) is thus completed in the TA 34 service area 10.

Assuming that mobile terminal 26(d) is to be allowed access and registration procedures are completed, mobile terminal 26(d) is provided services by the IP network 12 as follows. The TA 34 converts between wireless protocol, in this case GSM, from the wireless terminal 26(d), and the appropriate IP protocol, for example H.323, messages to gatekeeper 22. Of course, other protocols may be supported. The gatekeeper 22 processes the IP messages it receives from the TA 34 as if they had originated from a terminal within the IP network 12. In this example, the gatekeeper 22 allows the call to proceed to IP terminal 20(b). It should be understood that a similar procedure would apply for a mobile terminal anywhere within the service area of the terminal agent 34 which, in this example, is designed to coincide with the enterprise area 10. Thus, for example, mobile terminals 26(a) and 26(c) could communicate with IP terminals 20(a) and 20(b) in the same manner.

Further referring to FIG. 3, it should be understood that additional terminal agents, such as a terminal agent supporting WCDMA may be provided in order to service wireless terminals using various wireless system protocols such as, for example, WCDMA. For instance, if wireless terminal 26(c) were a WCDMA terminal and terminal agent 34 were configured to provide service to WCDMA wireless terminals, then an access request from wireless terminal 26(c) would be detected by WCDMA terminal agent 34 and WCDMA terminal agent 34 would then perform necessary registration techniques known in the arts, and convert between WCDMA protocol and the IP protocol of IP network 12. The call would then continue through the IP network 12 to its destination as in the preceding example.

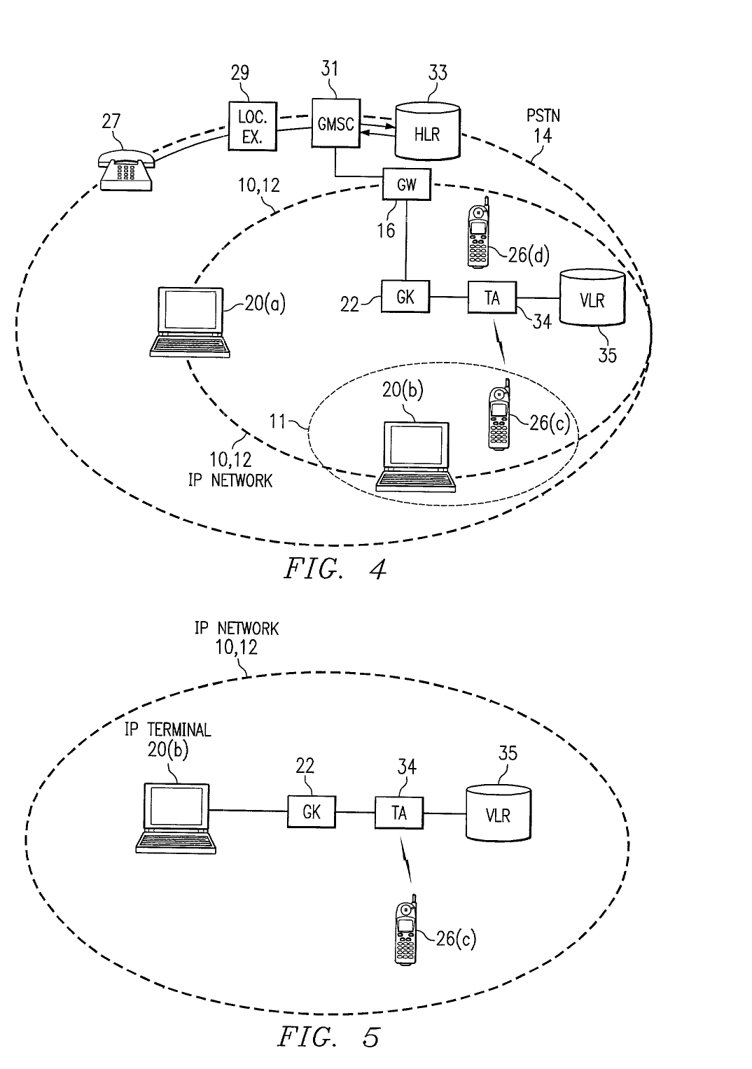

In FIG. 4, the progression of a call from a PSTN terminal 27 to a mobile terminal 26(c) within the enterprise site 11 is illustrated. The MSISDN is provided by PSTN terminal 27 is routed according to known PSTN 14 protocols that permits a local exchange 29 and gateway MSC (GMSC) 31 to deliver a routing request to the HLR 33. Once routing information is obtained, a connection is established between the GMSC 31 and IP network 10, through gateway 16. Within the service area 12 of the IP network 10, the gatekeeper 22 is configured to communicate with the TA 34 which is able to verify the registration of the mobile terminal 26(c). The air interface capabilities of the TA 34 are used to make the final connection with the destination mobile terminal 26(c). As in the previous examples, the TA 34 performs the appropriate protocol conversions.

It should be apparent to those skilled in the arts that PSTN terminal 27 uses the appropriate PSTN protocol and infrastructure in establishing and using the link through the IP network gateway 16. From gateway 16 up to and including TA 34, call set-up and pay load is carried utilizing IP network protocol, in this case H.323. Between terminal agent 34 and mobile terminal 26(c), the appropriate wireless interface is used, such as, for example, GSM. It should also be apparent to those skilled in the arts that mobile terminal 26(c) is used within the IP network 12 of the enterprise site 11 without invoking the resources of its home PLMN network. In this way, the mobile terminal 26(c) is treated as if it were a terminal of the enterprise site 11.

FIG. 5 illustrates an alternate use of the invention that permits an IP terminal 20(b) of the IP network 12 to place a call to a mobile terminal 26(c) located within the service area of the enterprise site 10. The IP terminal 20(b) initiates the call through gatekeeper 22. Gatekeeper 22 is linked with TA 34 whereby the registration of the mobile terminal 26(c) within the IP network service area 10 is verified. The TA 34 then provides the protocol conversion and air interface link with mobile terminal 26(c). In this way, two terminals can communicate using IP network 10 infrastructure without additional PLMN network 24 resources which would otherwise be required to provide service to mobile terminal 26(c) outside of the service area 10 of TA 34.

It should be clear from the preceding examples that many other variations are possible, all within the scope of the invention. For instance, the roles of the origination and destination terminals could be reversed, or additional variations of the examples above could be assembled, according to the principles of above-illustrated examples.

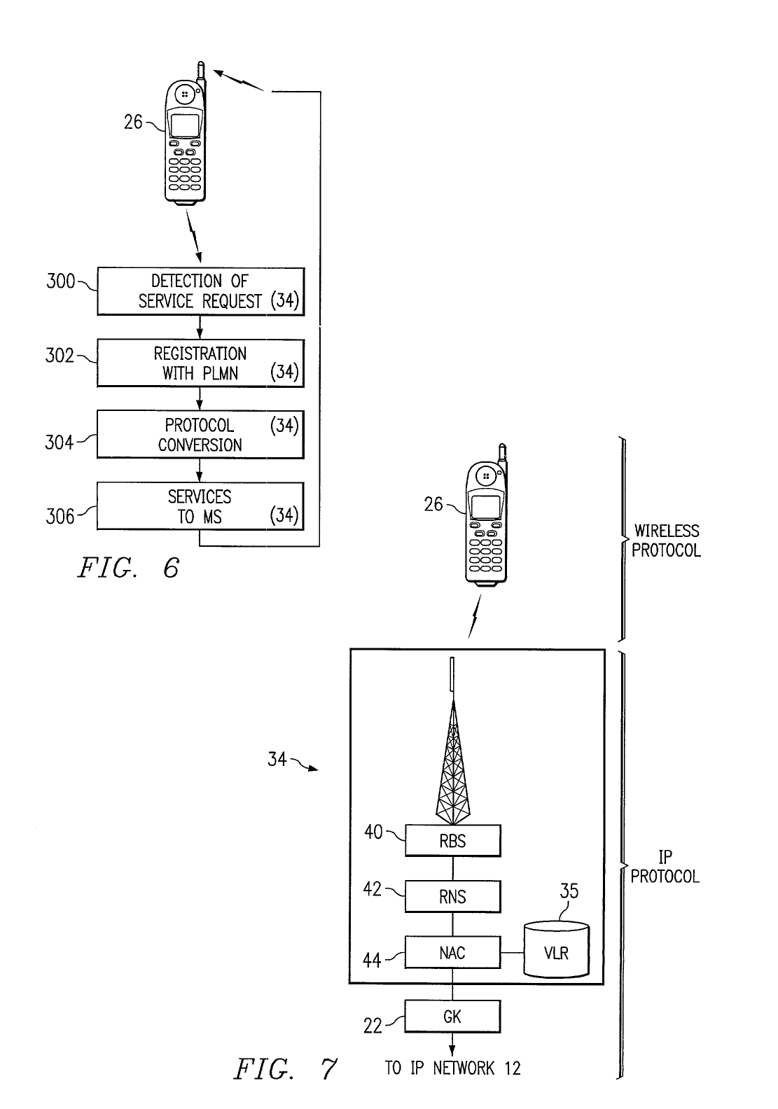

FIG. 6 is a process flow diagram for the method of the invention as shown and described with reference to FIGS. 2-4. A terminal service request is received at step 300 and detected by the TA 34. At step 304, the wireless protocol signal of the mobile terminal is converted to an IP protocol message. At step 306, the incoming call is linked via the IP network to the appropriate IP terminal, establishing two-way communication between the originating wireless terminal and the IP destination terminal.

FIG. 7 is a block diagram illustrating the essential components of a terminal agent apparatus, such as TA 34, suitable for implementing the invention. The terminal agent 34 has a Radio Base Station (RBS) 40 for providing radio service to a wireless terminal 26. A Radio Network Server (RNS) 42 is connected to the RBS 40 for performing Radio Frequency (RF) signal processing and for controlling the RBS 40 operation. The RNS 42 includes functionality corresponding to a BSC. A Network Access Controller (NAC) 44 is connected to the Radio Network Server (RNS) 42 and is configured to convert signals between a wireless protocol, GSM for example, and IP protocol, such as H.323, for facilitating transmission of the signals between the IP network 12 and the mobile terminal 26. The NAC 44 includes MSCNLR functionality as found in the PLMN. The terminal agent 34 also has access to the PLMN registration system known in the arts (not shown). The NAC 44 communicates with the gatekeeper 22, and thereby to any other terminal 20(a . . . n) of the IP network 12.

The embodiments shown and described above are only exemplary. Even though numerous characteristics and advantages of the present invention have been set forth in the foregoing description together with details of the method of the invention, the disclosure is illustrative only and changes may be made within the principles of the invention to the full extent indicated by the broad general meaning of the terms used in the attached claims.

We claim:

1. A method of providing wireless terminal service in an Internet Protocol (IP) network comprising the steps of:
a wireless terminal requesting service utilizing a wireless protocol;
a terminal agent of the IP network detecting the request for service in a service area supported by terminal agent;
the terminal agent providing a wireless interface to the wireless terminal;
the terminal agent also providing an IP interface to the IP network; and
the terminal agent converting between wireless protocol and IP protocol whereby the wireless terminal is served by the IP network.

2. A method according to claim 1 further comprising the step of the IP network treating the wireless terminal as an IP terminal of the IP network.

3. A method according to claim 1 further comprising the step of the wireless terminal treating the terminal agent as an MSC of its Public Land Mobile Network, PLMN.

4. A method according to claim 1 further comprising the step of the terminal agent registering the wireless terminal in a Home Location Register, HLR of the PLMN of the wireless terminal.

5. A method according to claim 1 further comprising the step of the terminal agent registering the wireless terminal in the IP network.

6. A method according to claim 1 further comprising the step of the terminal agent communicating with the IP network using H.323 protocol.

7. A method according to claim 1 further comprising the step of the terminal agent communicating with the IP network using Session Initiation Protocol, SIP.

8. A method according to claim 1 further comprising the step of the wireless terminal treating the terminal agent as a Global System for Mobile communication, GSM, network.

9. A method according to claim 1 further comprising the step of the wireless terminal treating the terminal agent as a Code Division Multiple Access, CDMA, network.

10. A method according to claim 1 further comprising the step of the wireless terminal treating the terminal agent as a Digital Advanced Mobile Phone System, DAMPS, network.

11. A method according to claim 1 further comprising the step of the wireless terminal treating the terminal agent as a Personal Digital Cellutar, PDC, network.

12. A communication system providing wireless terminal service in an IP network comprising:
a gatekeeper for controlling access by IP terminals to the IP network; and
a terminal agent configured to facilitate IP network support of a wireless terminal not connected to the IP network, the terminal agent appearing as an IP terminal to the gatekeeper.

13. A system according to claim 12 wherein the terminal agent is configured to emulate a PLMN with respect to the wireless terminal.

14. A system according to claim 12 wherein the terminal agent further comprises a Home Location Register, HLR, for registering the wireless terminal.

15. A system according to claim 12 wherein the terminal agent further comprises a Visitor Location Register, VLR, for registering the wireless terminal with the Home Location Register, HLR, of the wireless terminal PLMN.

16. A system according to claim 12 wherein the terminal agent is configured to emulate an IP network terminal with respect to the gatekeepers.

17. A system according to claim 12 wherein the IP network comprises an H.323 network.

18. A system according to claim 12 wherein the IP network comprises a Session Initiation Protocol, SIP, network.

19. A system according to claim 12 wherein the wireless terminal comprises a GSM terminal.

20. A system according to claim 12 wherein the wireless terminal comprises a Code Division Multiple Access, CDMA, terminal.

21. A system according to claim 12 wherein the wireless terminal comprises a Digital Advanced Mobile Phone System, DAMPS, terminal.

22. A system according to claim 12 wherein the wireless terminal comprises a Personal Digital Cellular, PDC, terminal.

23. A terminal agent for interfacing a wireless terminal with an IP communication network comprising:
a transceiver for providing radio service to a wireless terminal;
a Radio Network Server, RNS, operably coupled to the transceiver for radio signal processing and transceiver control; and
a Network Access Controller, NAC, operably coupled to the RNS for conversion of signals between wireless protocol and IP protocol for facilitating exchange of the signals between the wireless terminal and the IP network.

24. A terminal agent according to claim 23 wherein the terminal agent is configured to emulate a PLMN with respect to the wireless terminal.

25. A terminal agent according to claim 23 wherein the terminal agent further comprises a Visitor Location Register, VLR, for registering the wireless terminal with the wireless terminal PLMN.

26. A terminal agent according to claim 23 wherein the terminal agent is configured to emulate an IP network terminal with respect to the IP network.

27. A terminal agent according to claim 23 wherein the IP network comprises an H.323 network.

28. A terminal agent according to claim 23 wherein the IP network comprises a Session Initiation Protocol (SIP) network.

29. A terminal agent according to claim 23 wherein the wireless terminal comprises a GSM terminal.

30. A terminal agent according to claim 23 wherein the wireless terminal comprises a CDMA terminal.

31. A terminal agent according to claim 23 wherein the wireless terminal comprises a DAMPS terminal.

32. A terminal agent according to claim 23 wherein the wireless terminal comprises a PDC terminal.
